(19) United States
(12) Patent Application Publication
(10) Pub. No.: US 2026/0365224 A1
(43) Pub. Date: Nov. 19, 2026

(54) STEERING COLUMN FOR VEHICLE

(71) Applicant: HL MANDO CORPORATION, Gyeonggi-do (KR)

(72) Inventor: Hyun KIM, Gyeonggi-do (KR)

(21) Appl. No.: 19/409,641

(22) Filed: Dec. 4, 2025

(30) Foreign Application Priority Data
May 16, 2025 (KR) 10-2025-0064015

(51) Int. Cl. B62D 1/185

(52) U.S. Cl. CPC B62D 1/185

(57) ABSTRACT

Provided is a steering column for a vehicle, the steering column including a tube housing coupled to a mounting bracket and fixed to a vehicle body of a vehicle, a middle tube coupled to be slidable inside the tube housing and configured to move in an axial direction, an inner tube having an inner side to which a steering shaft is rotatably coupled, and an outer side to which the middle tube is slidably coupled, the inner tube being configured to move in the axial direction, and a rebound stopper member coupled to the middle tube and configured to support the inner tube.

### CROSS-REFERENCE TO RELATED APPLICATIONS

This application claims the priority of Korean Patent Application No. 10-2025-0064015 filed on May 16, 2025, in the Korean Intellectual Property Office, the disclosure of which is incorporated herein by reference.

### BACKGROUND

### Field

The present embodiments relate to a steering column for a vehicle, and more particularly, to a steering column for a vehicle that may perform a telescopic motion of adjusting an axial length of the steering column and a stowing motion of retracting a steering wheel into a dashboard or extending the steering wheel outward.

### Description of the Related Art

In general, a steering column for a vehicle includes telescopic and tilting functions. With these functions, a driver may adjust a degree to which a steering wheel protrudes and an inclination angle of the steering wheel suitable for the driver's height or body type, thereby smoothly performing a steering operation.

Recently, a steer-by-wire steering apparatus, which excludes connection components that mechanically connect components, such as a shaft, a universal joint, or a pinion shaft, between the steering wheel and wheels and uses an electric motor, such as a motor, to steer the vehicle, has been developed and applied.

Further, with the development of the steer-by-wire steering apparatus, a steering column has been developed which enables autonomous driving that allows the driver to autonomously reach the destination without manipulating the steering wheel, an accelerator pedal, a brake, and the like. Further, there is a need to ensure a larger space to provide convenience for the driver seated in a driver seat during autonomous driving.

To this end, research has been conducted on increasing telescopic retraction and extension distances of a steering shaft or increasing a stowing distance by which the steering wheel is retracted into a dashboard or extended outward.

However, when the retraction and extension distances of the steering column for a vehicle increase, retraction and extension speeds also increase, and rebound of an inner tube or a middle tube occurs when collapse of a steering column is implemented in the event of a vehicle collision, which causes a problem in that sufficient stability and convenience for the driver cannot be ensured.

Accordingly, there is a need for research on a steering column for a vehicle that may increase the retraction and extension distances of the steering column for a vehicle, quickly and stably perform an operation when the collapse of the steering column is implemented in the event of a vehicle collision, and ensure both safety and convenience for the driver.

### SUMMARY

The present embodiments have been made in view of the above-mentioned background, and the present embodiments relate to a steering column for a vehicle that may more quickly and stably perform a telescopic motion of adjusting an axial length of the steering column for a vehicle and a stowing motion of retracting a steering wheel into a dashboard or extending the steering wheel outward.

In addition, the present embodiments relate to a steering column for a vehicle that may prevent rebound of an inner tube or a middle tube when collapse of the steering column is implemented in the event of a vehicle collision, thereby performing stable retraction and extension operations and providing sufficient stability and convenience for a driver.

The present embodiments may provide a steering column for a vehicle, the steering column including: a tube housing coupled to a mounting bracket and fixed to a vehicle body of a vehicle; a middle tube coupled to be slidable inside the tube housing and configured to move in an axial direction; an inner tube having an inner side to which a steering shaft is rotatably coupled, and an outer side to which the middle tube is slidably coupled, the inner tube being configured to move in the axial direction; and a rebound stopper member coupled to the middle tube and configured to support the inner tube.

In the present embodiments, the middle tube may be provided with a through-hole, and the rebound stopper member may be coupled to the through-hole.

In the present embodiments, a stopper protrusion may be provided inside the rebound stopper member and protrude in a radial direction, and the stopper protrusion may be supported on an outer peripheral surface of the inner tube.

In the present embodiments, an insertion groove may be provided in the outer peripheral surface of the inner tube, and the stopper protrusion may be inserted into the insertion groove.

In the present embodiments, the rebound stopper member may include: a tube support member having a central portion on which the stopper protrusion is provided; and a cylinder member configured to accommodate the tube support member and coupled to the through-hole.

In the present embodiments, at least one planar portion may be provided on an outer peripheral surface of the cylinder member, an insertion support portion may be provided in the through-hole, and the planar portion may be inserted into and supported by the insertion support portion.

In the present embodiments, a fastening groove may be provided in an outer peripheral surface of the cylinder member and formed in a circumferential direction, and a portion of the middle tube provided around the through-hole may be inserted into the fastening groove.

In the present embodiments, the rebound stopper member may further include a stopper support member coupled to the cylinder member and configured to support the tube support member toward the inner tube.

In the present embodiments, threaded portions may be formed on an outer peripheral surface of the stopper support member and an inner peripheral surface of the cylinder member, and the stopper support member and the cylinder member may be screw-coupled.

In the present embodiments, the rebound stopper member may further include an elastic member coupled between the tube support member and the stopper support member and configured to elastically support the tube support member.

In the present embodiments, the elastic member may be formed in a ring shape having an inclined surface from an inner peripheral surface thereof to an outer peripheral surface thereof.

In the present embodiments, the elastic member may be provided as two or more elastic members coupled between the tube support member and the stopper support member.

In the present embodiments, a protruding accommodation portion may be provided at an end of the tube housing into which the middle tube is inserted, and the protruding accommodation portion may accommodate the rebound stopper member during collapse.

In the present embodiments, a side of the protruding accommodation portion, which is directed toward an end of the tube housing, may be opened, and the protruding accommodation portion may protrude in a radial direction from an outer peripheral surface of the tube housing.

In the present embodiments, the tube housing may be provided with a connection rib configured to connect the outer peripheral surface of the tube housing and a lateral surface of the protruding accommodation portion.

According to the present embodiments described above, it is possible to more quickly and stably perform the telescopic motion of adjusting the axial length of the steering column for a vehicle and the stowing motion of retracting the steering wheel into the dashboard or extending the steering wheel outward.

In addition, according to the present embodiments, it is possible to prevent rebound of the inner tube or the middle tube when collapse of the steering column is implemented in the event of a vehicle collision, thereby performing stable retraction and extension operations and providing sufficient stability and convenience for the driver.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a perspective view of a steering column for a vehicle according to the present embodiments;

FIGS. 2 and 3 are exploded perspective views of a part of the steering column for a vehicle according to the present embodiments;

FIG. 4 is a cross-sectional view illustrating a state made before collapse of the steering column for a vehicle according to the present embodiments;

FIG. 5 is an enlarged view of part A in FIG. 4;

FIG. 6 is a cross-sectional view illustrating a state made after collapse of the steering column for a vehicle according to the present embodiments;

FIG. 7 is an enlarged view of part B in FIG. 6;

FIG. 8 is a cross-sectional view of part C-C in FIG. 4; and

FIG. 9 is a cross-sectional view of part D-D in FIG. 6.

### DETAILED DESCRIPTION OF THE EMBODIMENT

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

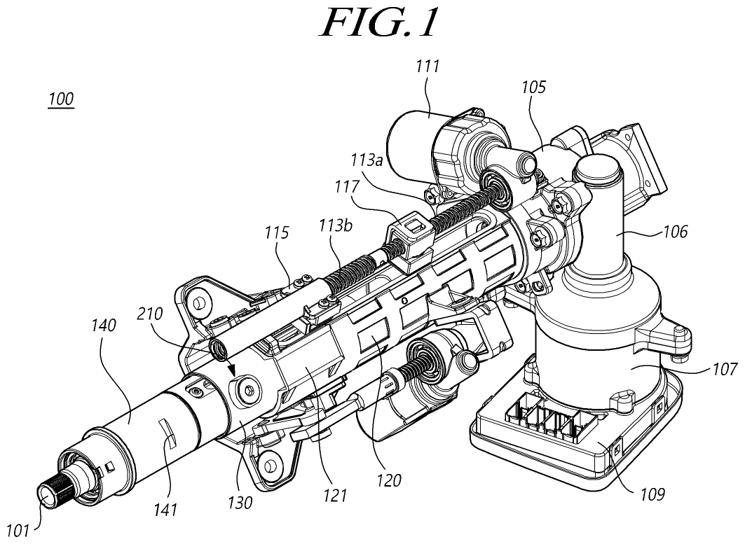

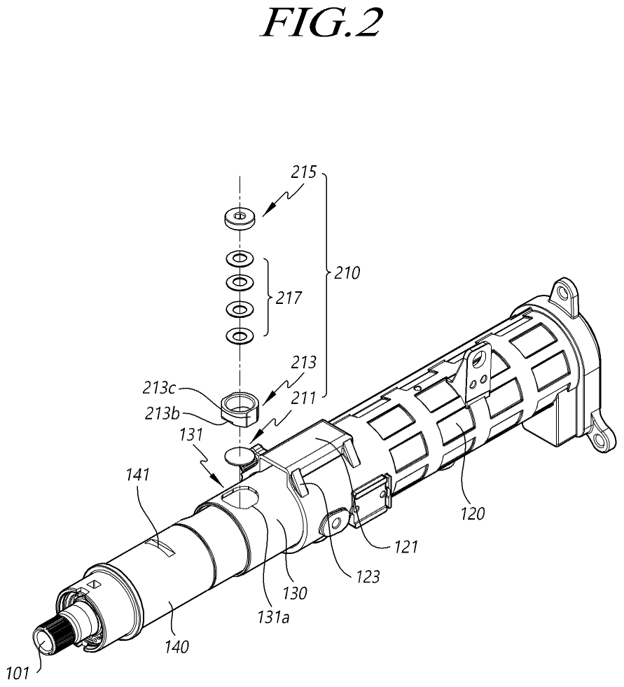

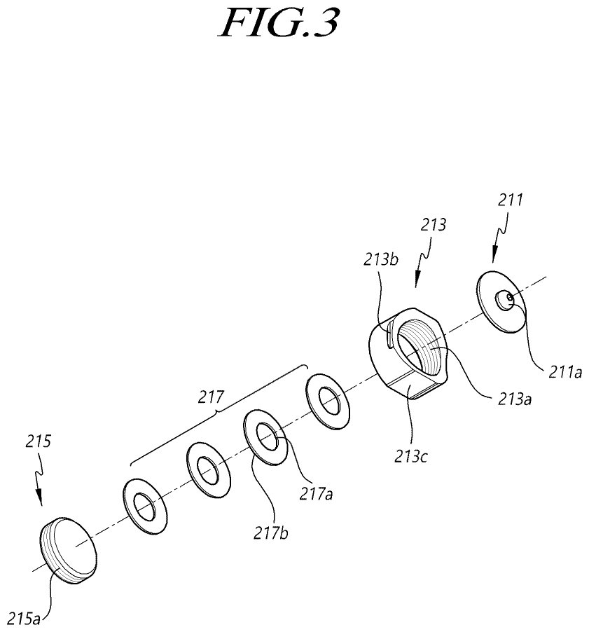

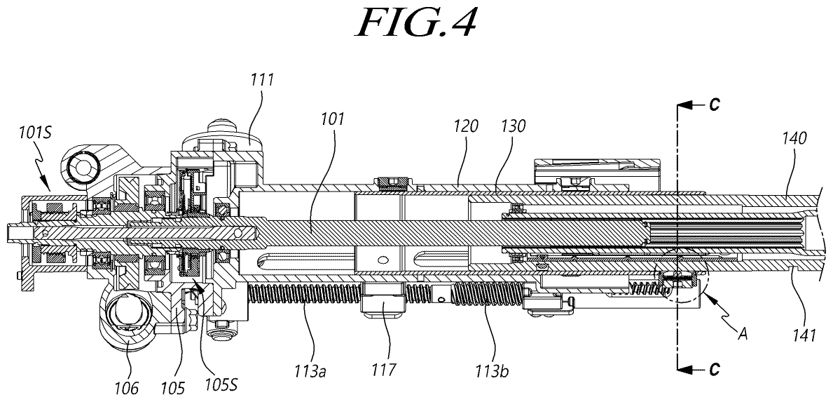

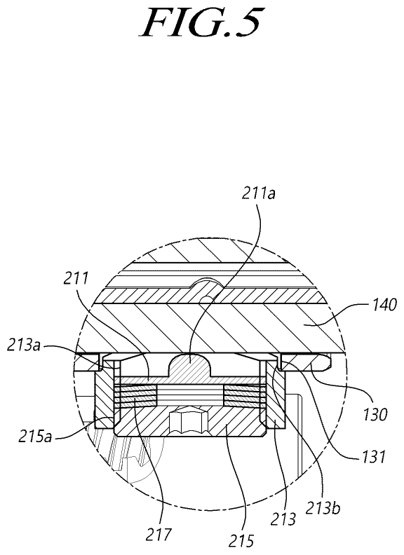

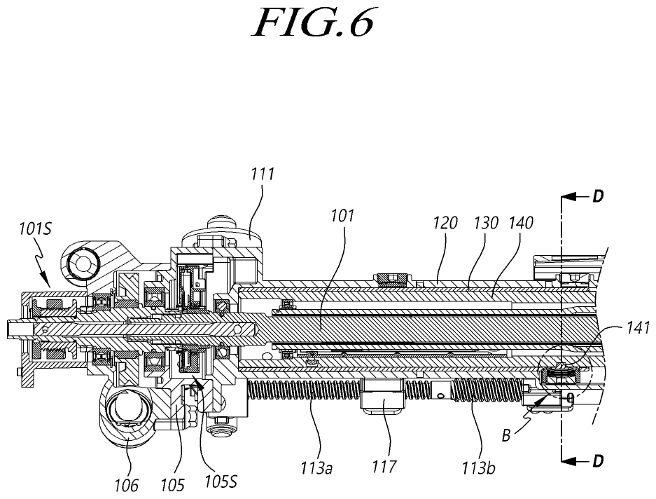

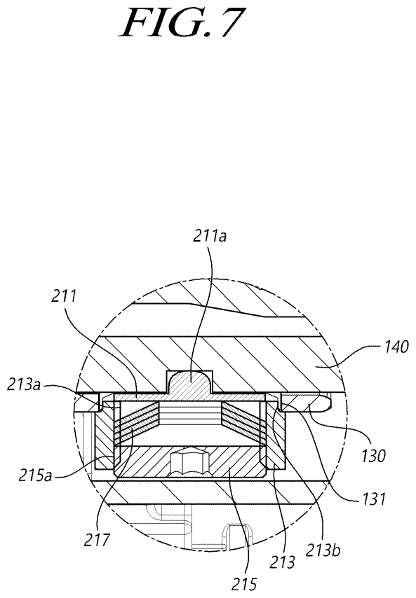

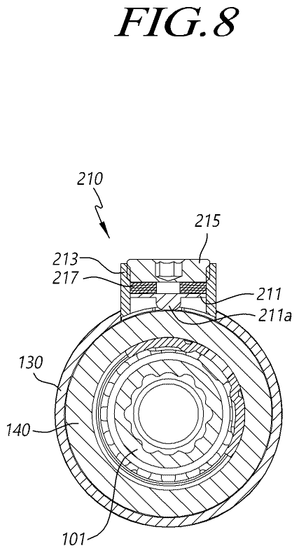

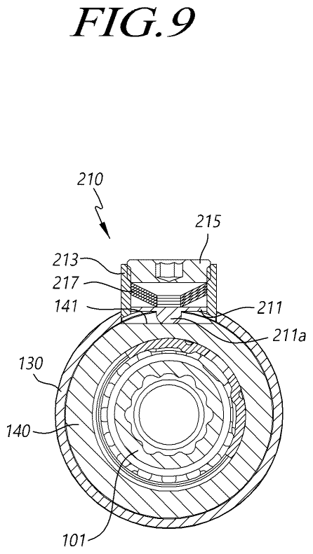

FIG. 1 is a perspective view of a steering column for a vehicle according to the present embodiments, FIGS. 2 and 3 are exploded perspective views of a part of the steering column for a vehicle according to the present embodiments, FIG. 4 is a cross-sectional view illustrating a state made before collapse of the steering column for a vehicle according to the present embodiments, FIG. 5 is an enlarged view of part A in FIG. 4, FIG. 6 is a cross-sectional view illustrating a state made after collapse of the steering column for a vehicle according to the present embodiments, FIG. 7 is an enlarged view of part B in FIG. 6, FIG. 8 is a cross-sectional view of part C-C in FIG. 4, and FIG. 9 is a cross-sectional view of part D-D in FIG. 6.

In the following detailed description of the present embodiments with reference to FIGS. 1 to 9, an upward direction refers to a direction directed toward a steering wheel, and a downward direction refers to a direction opposite to the upward direction. Further, the description will be described on the assumption that among operations including retraction and extension, a retraction operation and a collapse operation refer to operations of moving the steering wheel downward so that an axial length of a steering column 100 decreases, and an extension operation and a rebound operation refer to operations of moving the steering wheel upward so that the axial length of the steering column 100 increases.

The steering column 100 for a vehicle according to the present embodiments includes a tube housing 120 coupled to a mounting bracket 103 and fixed to a vehicle body of a vehicle, a middle tube 130 coupled to be slidable inside the tube housing 120 and configured to move in an axial direction, an inner tube 140 having an inner side to which a steering shaft 101 is rotatably coupled, and an outer side to which the middle tube 130 is slidably coupled, the inner tube 140 being configured to move in the axial direction, and a rebound stopper member 210 coupled to the middle tube 130 and configured to support the inner tube 140.

The mounting bracket 103 is provided with a fixing flange and a fixing hole so that the mounting bracket 103 is fixed to the vehicle body of the vehicle. Therefore, the steering column 100 is fixed to the vehicle body of the vehicle, and a steering wheel (not illustrated) is coupled to a leading end of the steering shaft 101, such that a steering manipulation is performed by a driver.

In the steering column 100 according to the present embodiments, the middle tube 130 is slidably coupled to the tube housing 120, such that retraction and extension motions are performed in the axial direction.

Further, the inner tube 140, which has the inner side to which the steering shaft 101 is rotatably coupled, is inserted into the middle tube 130, such that the retraction and extension motions are performed in the axial direction.

In the present embodiments, the retraction and extension motions include a telescopic motion of adjusting a length of the steering column 100 and a stowing motion of retracting the steering wheel into a dashboard or extending the steering wheel outward. The retraction and extension motions broadly include a collapse operation of the steering column 100 that occurs in the direction of a vehicle collision.

A motor 111 provided at a lower end of the tube housing 120 rotates a first screw 113a and a second screw 113b, and a first nut 117, which is coupled to the first screw 113a, and a second nut 115, which is coupled to the second screw 113b, slide the middle tube 130 and the inner tube 140 in the axial direction.

The axial retraction and extension motions of the tube housing 120, the middle tube 130, and the inner tube 140 include the telescopic motion or the stowing motion and the collapse operation performed by the driver.

A lower end of the tube housing 120 is coupled to a sensor housing 105 embedded with a torque angle sensor 105s, and a speed reducer housing 106 is coupled to the sensor housing 105 and configured to reduce driving power of the motor 111 by using a worm and a worm wheel.

As illustrated in FIG. 2, the middle tube 130 may be provided with a through-hole 131, and the rebound stopper member 210 may be coupled to the through-hole 131 and support an outer peripheral surface of the inner tube 140.

In addition, a stopper protrusion 211a, which protrudes in a radial direction, may be provided inside the rebound stopper member 210, and the stopper protrusion 211a may be supported on the outer peripheral surface of the inner tube 140.

The stopper protrusion 211a may protrude in a hemispherical shape or a wedge shape.

Further, an insertion groove 141 is provided in an outer peripheral surface of an upper portion of the inner tube 140. The stopper protrusion 211a is inserted into the insertion groove 141 when the inner tube 140 moves in the axial direction during collapse.

The insertion groove 141 is elongated in a circumferential direction, such that the inner tube 140 may be coupled to the stopper protrusion 211a even though the inner tube 140 rotates during collapse occurring in the event of a vehicle collision.

As illustrated in FIGS. 2 and 3, the rebound stopper member 210 includes a tube support member 211 having a central portion on which the stopper protrusion 211a is provided, and a cylinder member 213 configured to accommodate the tube support member 211 and coupled to the through-hole 131.

At least one planar portion 213c may be provided on an outer peripheral surface of the cylinder member 213, an insertion support portion 131a may be provided in the through-hole 131 of the middle tube 130, and the planar portion 213c may be inserted into and supported by the insertion support portion 131a.

Therefore, a coupling position between the through-hole 131 and the cylinder member 213, which accommodates the tube support member 211 configured to support an outer peripheral surface of the middle tube 130 having a curved shape, may be accurately maintained.

In addition, a fastening groove 213b may be provided in the outer peripheral surface of the cylinder member 213 and formed in a circumferential direction, and a portion of the middle tube 130 provided around the through-hole 131 may be inserted into the fastening groove 213b.

That is, the fastening groove 213b is formed in an outer peripheral surface of an end of the cylinder member 213 and has a height equal to a thickness of the middle tube 130, such that the portion of the middle tube 130 provided around the through-hole 131 may be seated on and coupled to the fastening groove 213b when the cylinder member 213 is coupled to the through-hole 131.

Therefore, a height and position at which the cylinder member 213 is coupled to the through-hole 131 may be accurately maintained, and the cylinder member 213 may be assembled without being rotated.

In addition, the rebound stopper member 210 may further include a stopper support member 215 coupled to the cylinder member 213 and configured to support the tube support member 211 toward the inner tube 140.

The stopper support member 215 may be press-fitted into an inner peripheral surface of the cylinder member 213. In this case, a load by which the tube support member 211 supports the inner tube 140 may be adjusted in accordance with a depth to which the stopper support member 215 is press-fitted.

In addition, the stopper support member 215 may be screw-coupled to the inner peripheral surface of the cylinder member 213.

In this case, threaded portions 215a and 213a may be formed on an outer peripheral surface of the stopper support member 215 and the inner peripheral surface of the cylinder member 213, such that the stopper support member 215 and the cylinder member 213 may be screw-coupled. A load by which the stopper support member 215 supports the inner tube 140 may be adjusted in accordance with a degree to which the stopper support member 215 is screw-tightened.

In addition, the rebound stopper member 210 may further include elastic members 217 coupled between the tube support member 211 and the stopper support member 215 and configured to elastically support the tube support member 211.

The elastic member 217 may be formed in a ring or cone shape having an inclined surface from an inner peripheral surface 217a to an outer peripheral surface 217b. However, the present disclosure is not necessarily limited thereto. A coil spring, which may be coupled between the tube support member 211 and the stopper support member 215, may be used.

Two or more elastic members 217 may be coupled between the tube support member 211 and the stopper support member 215. FIGS. 2 to 9 illustrate an example in which four elastic members 217 are stacked and coupled between the tube support member 211 and the stopper support member 215.

A protruding accommodation portion 121 may be provided at an end of the tube housing 120 into which the middle tube 130 is inserted. The protruding accommodation portion 121 may accommodate the rebound stopper member 210 during the collapse of the steering column that occurs in the event of a vehicle collision.

The protruding accommodation portion 121 protrudes in the radial direction from the outer peripheral surface of the tube housing 120 so that a side of the protruding accommodation portion 121, which is directed toward the end of the tube housing 120, is opened.

The protruding accommodation portion 121 protrudes so that a degree to which the protruding accommodation portion 121 protrudes is larger than a degree to which the rebound stopper member 210 protrudes in the radial direction. The protruding accommodation portion 121 is elongated in the axial direction and has a width larger than a circumferential width of the rebound stopper member 210.

Therefore, even though the middle tube 130 is retracted in the axial direction during the collapse of the steering column that occurs in the event of a vehicle collision, the rebound stopper member 210 does not interfere with the tube housing 120 or the protruding accommodation portion 121, and as a result, the collision performance of the steering column is not affected.

In addition, the tube housing 120 may be provided with a connection rib 123 configured to connect the outer peripheral surface of the tube housing 120 and a lateral surface of the protruding accommodation portion 121.

Therefore, the connection rib 123 improves the rigidity of the protruding accommodation portion 121 and portions adjacent to the protruding accommodation portion 121, such that interference with the rebound stopper member 210 caused by deformation of the protruding accommodation portion 121 in the event of a vehicle collision is prevented, and the collision performance of the steering column is not affected.

The steering column for a vehicle according to the present embodiments described above may not only be applied to a general steering column for a vehicle, which allows the driver to steer the vehicle, but also be applied to a steering column for a vehicle that enables autonomous driving.

In particular, with reference to a steer-by-wire steering apparatus that enables autonomous driving, the torque angle sensor 105s, which detects a manipulation of the steering wheel by the driver, transmits an electrical signal to an electronic control device 109, such that a steering wheel motor 107 and a pinion shaft motor (not illustrated) are operated.

The electronic control device 109 controls the steering wheel motor 107 and the pinion shaft motor based on the electrical signal transmitted from the torque angle sensor 105s and electrical signals transmitted from several sensors mounted in the vehicle.

The steering wheel motor 107 is connected to the speed reducer housing 106 configured to reduce a rotational speed of the motor. During normal traveling, the steering wheel motor 107 provides a reaction force to the steering wheel so that the driver may perceive a steering reaction force in an opposite direction when the driver manipulates the steering wheel. During autonomous driving, the steering is performed under the control of the electronic control device 109 without intervention of the driver's intention.

Further, in the steer-by-wire steering apparatus, a rotation angle restriction member 101s configured to restrict a rotation angle of the steering shaft 101 is provided at a lower end of the speed reducer housing 106.

According to the present embodiments described above, it is possible to more quickly and stably perform the telescopic motion of adjusting the axial length of the steering column for a vehicle and the stowing motion of retracting the steering wheel into the dashboard or extending the steering wheel outward.

In addition, according to the present embodiments, it is possible to prevent rebound of the inner tube or the middle tube when collapse of the steering column is implemented in the event of a vehicle collision, thereby performing stable retraction and extension operations and providing sufficient stability and convenience for the driver.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims.

What is claimed is:

1. A steering column for a vehicle, the steering column comprising:
a tube housing coupled to a mounting bracket and fixed to a vehicle body of a vehicle;
a middle tube coupled to be slidable inside the tube housing and configured to move in an axial direction;
an inner tube having an inner side to which a steering shaft is rotatably coupled, and an outer side to which the middle tube is slidably coupled, the inner tube being configured to move in the axial direction; and
a rebound stopper member coupled to the middle tube and configured to support the inner tube.

2. The steering column of claim 1, wherein the middle tube is provided with a through-hole, and the rebound stopper member is coupled to the through-hole.

3. The steering column of claim 2, wherein a stopper protrusion is provided inside the rebound stopper member and protrudes in a radial direction, and the stopper protrusion is supported on an outer peripheral surface of the inner tube.

4. The steering column of claim 3, wherein an insertion groove is provided in the outer peripheral surface of the inner tube, and the stopper protrusion is inserted into the insertion groove.

5. The steering column of claim 3, wherein the rebound stopper member comprises:
a tube support member having a central portion on which the stopper protrusion is provided; and
a cylinder member configured to accommodate the tube support member and coupled to the through-hole.

6. The steering column of claim 5, wherein at least one planar portion is provided on an outer peripheral surface of the cylinder member, an insertion support portion is provided in the through-hole, and the planar portion is inserted into and supported by the insertion support portion.

7. The steering column of claim 5, wherein a fastening groove is provided in an outer peripheral surface of the cylinder member and formed in a circumferential direction, and a portion of the middle tube provided around the through-hole is inserted into the fastening groove.

8. The steering column of claim 5, wherein the rebound stopper member further comprises a stopper support member coupled to the cylinder member and configured to support the tube support member toward the inner tube.

9. The steering column of claim 8, wherein threaded portions are formed on an outer peripheral surface of the stopper support member and an inner peripheral surface of the cylinder member, and the stopper support member and the cylinder member are screw-coupled.

10. The steering column of claim 8, wherein the rebound stopper member further comprises an elastic member coupled between the tube support member and the stopper support member and configured to elastically support the tube support member.

11. The steering column of claim 10, wherein the elastic member is formed in a ring shape having an inclined surface from an inner peripheral surface thereof to an outer peripheral surface thereof.

12. The steering column of claim 10, wherein the elastic member is provided as two or more elastic members coupled between the tube support member and the stopper support member.

13. The steering column of claim 1, wherein a protruding accommodation portion is provided at an end of the tube housing into which the middle tube is inserted, and the protruding accommodation portion accommodates the rebound stopper member during collapse.

14. The steering column of claim 13, wherein a side of the protruding accommodation portion, which is directed toward an end of the tube housing, is opened, and the protruding accommodation portion protrudes in a radial direction from an outer peripheral surface of the tube housing.

15. The steering column of claim 14, wherein the tube housing is provided with a connection rib configured to connect the outer peripheral surface of the tube housing and a lateral surface of the protruding accommodation portion.
